(19) United States
(12) Patent Application Publication
(10) Pub. No.: US 2005/0039189 A1
(43) Pub. Date: Feb. 17, 2005

(54) Methods and apparatus to preemptively compile an application

(76) Inventors: Todd Anderson, Beaverton, OR (US); Joel Marcey, Folsom, CA (US)

Correspondence Address: GROSSMAN & FLIGHT LLC, Suite 4220, 20 North Wacker Drive, Chicago, IL, 60606-6357, US

(21) Appl. No.: 10/641,176

(22) Filed: Aug. 14, 2003

(51) Int. Cl. G06F 9/46

(52) U.S. Cl. 719/314

(57) ABSTRACT

Methods and apparatus to preemptively compile an application are disclosed. In an example method, at least one preemptive compilation thread (PCT) is generated. Data associated with at least one method of the application is identified in a preemptive compilation priority queue (PCPQ). The at least one method identified in the PCPQ is converted into native code by executing the PCT.

### TECHNICAL FIELD

The present disclosure relates generally to compilers, and more particularly, to methods and apparatus to preemptively compile an application.

### BACKGROUND

Typically for a processor to run an application, a number of methods (i.e., functions for manipulating data) associated with the application may need to be compiled into instructions that the processor can execute. When the application is started in a current managed runtime environment (MRTE), methods of the application are converted to native code on an as-needed basis. In particular, a method is just-in-time (JIT) compiled when the first attempt to invoke the method is detected. Accordingly, the initial start-up time of an application is a function of compilation of the methods associated with that application.

When a user invokes an application, the processor will attempt to execute the first method of the application (e.g., a “Main( )” method in a C# program or a Java program). Typically, there is no warning prior to the user starting the application. Thus, the processor is forced to JIT compile the “main” method while the user waits because the main method has not been compiled to the native code for the processor to execute. The initial start-up time is further increased because the methods called by the main method are not compiled either. That is, the processor waits until those methods are actually called before compiling those methods. Especially for applications that start and/or stop frequently, the compilation time of an application may negatively affect the performance of the application and/or the platform operating the application.

### BRIEF DESCRIPTION OF THE DRAWINGS

FIG. 1 is a block diagram representation of an example processor system.

FIG. 2 is a block diagram representation of an example preemptive compilation system.

FIG. 3 is a block diagram representation of an example preemptive compilation priority queue (PCPQ).

FIG. 4 is a flow diagram representation of example machine readable instructions that may perform an application execution thread.

FIG. 5 is a flow diagram representation of example machine readable instructions that may perform a preemptive compilation thread.

FIG. 6 is a flow diagram representation of example machine readable instructions that may perform compilation of a method.

FIG. 7 is a block diagram representation of example preemptive compilation threads (PCT) and PCPQs.

FIG. 8 is a block diagram representation of the example PCTs and PCPQs shown in FIG. 7 in a first round of preemptive compilation.

FIG. 9 is a block diagram representation of the example PCTs and PCPQs shown in FIG. 7 in a second round of preemptive compilation.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

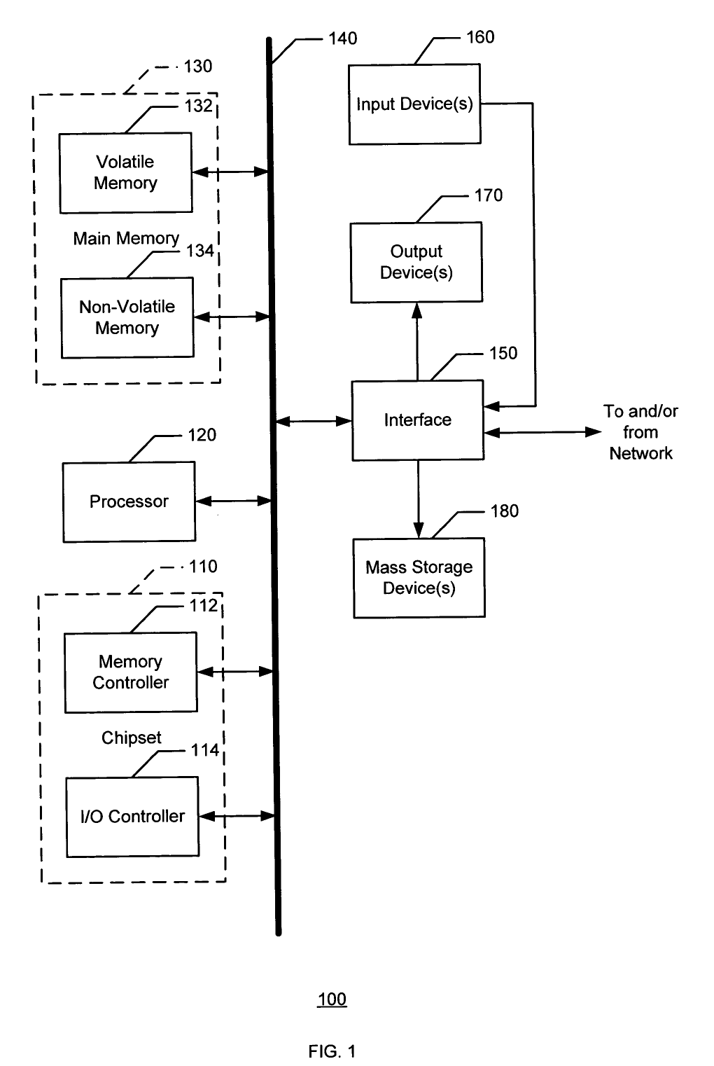

FIG. 1 is a block diagram of an example processor system 100 adapted to implement the methods and apparatus disclosed herein. The processor system 100 may be a desktop computer, a laptop computer, a notebook computer, a personal digital assistant (PDA), a server, an Internet appliance or any other type of computing device.

The processor system 100 illustrated in FIG. 1 includes a chipset 110, which includes a memory controller 112 and an input/output (I/O) controller 114. As is well known, a chipset typically provides memory and I/O management functions, as well as a plurality of general purpose and/or special purpose registers, timers, etc. that are accessible or used by a processor 120. The processor 120 is implemented using one or more processors. For example, the processor 120 may be implemented using one or more of the Intel® Pentium® family of microprocessors, the Intel® Itanium® family of microprocessors, Intel® Centrino® family of microprocessors, and/or the Intel XScale® family of processors. In the alternative, other processors or families of processors may be used to implement the processor 120.

As is conventional, the memory controller 112 performs functions that enable the processor 120 to access and communicate with a main memory 130 including a volatile memory 132 and a non-volatile memory 134 via a bus 140. The volatile memory 132 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 134 may be implemented by flash memory, Read Only Memory (ROM), Electrically Erasable Programmable Read Only Memory (EEPROM), and/or any other desired type of memory device.

The processor system 100 also includes a conventional interface circuit 150 that is coupled to the bus 140. The interface circuit 150 may be implemented using any type of well known interface standard such as an Ethernet interface, a universal serial bus (USB), a third generation input/output interface (3GIO) interface, and/or any other suitable type of interface.

One or more input devices 160 are connected to the interface circuit 150. The input device(s) 160 permit a user to enter data and commands into the processor 120. For example, the input device(s) 160 may be implemented by a keyboard, a mouse, a touch-sensitive display, a track pad, a track ball, an isopoint, and/or a voice recognition system.

One or more output devices 170 are also connected to the interface circuit 150. For example, the output device(s) 170 may be implemented by display devices (e.g., a light emitting display (LED), a liquid crystal display (LCD), a cathode ray tube (CRT) display, a printer and/or speakers). The interface circuit 150, thus, typically includes, among other things, a graphics driver card.

The processor system 100 also includes one or more mass storage devices 180 configured to store software and data. Examples of such mass storage device(s) 180 include floppy disks and drives, hard disk drives, compact disks and drives, and digital versatile disks (DVD) and drives.

The interface circuit 150 also includes a communication device such as a modem or a network interface card to facilitate exchange of data with external computers via a network. The communication link between the processor system 100 and the network may be any type of network connection such as an Ethernet connection, a digital subscriber line (DSL), a telephone line, a cellular telephone system, a coaxial cable, etc.

Access to the input device(s) 160, the output device(s) 170, the mass storage device(s) 180 and/or the network is typically controlled by the I/O controller 114 in a conventional manner. In particular, the I/O controller 114 performs functions that enable the processor 120 to communicate with the input device(s) 160, the output device(s) 170, the mass storage device(s) 180 and/or the network via the bus 140 and the interface circuit 150.

While the components shown in FIG. 1 are depicted as separate blocks within the processor system 100, the functions performed by some of these blocks may be integrated within a single semiconductor circuit or may be implemented using two or more separate integrated circuits. For example, although the memory controller 112 and the I/O controller 114 are depicted as separate blocks within the chipset 110, persons of ordinary skill in the art will readily appreciate that the memory controller 112 and the I/O controller 114 may be integrated within a single semiconductor circuit.

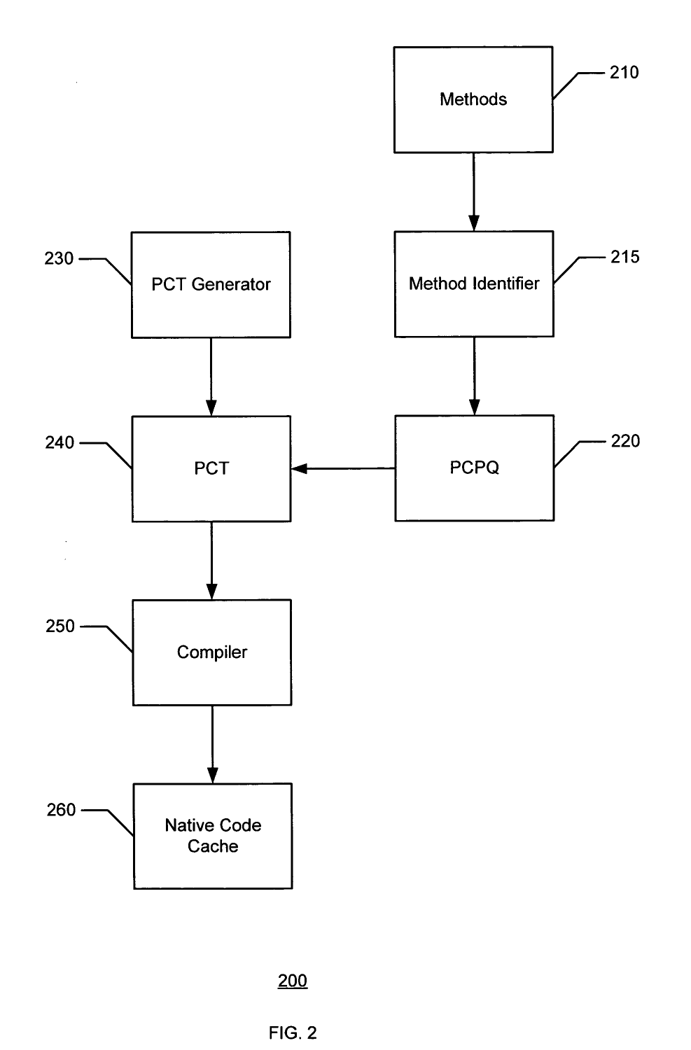

In the example of FIG. 2, the illustrated preemptive compilation system 200 includes a method identifier 215, a preemptive compilation priority queue (PCPQ) 220, a preemptive compilation thread (PCT) generator 230, a compiler 250, and a native code cache 260.

The method identifier 215 is configured to identify data associated with methods 210 associated with one or more applications to be executed by the processor system 100. As used herein “method” refers to one or more functions, routines, or subroutines for manipulating data. The identified data may be an uncompiled method and/or an identifier associated with the uncompiled method indicating where the uncompiled method is stored. The PCPQ 220 is configured to store data associated with the methods 210. For example, the PCPQ 220 may include methods 210 that are likely to be invoked soon by an application but have not been compiled to native code (i.e., at the time they were inserted into the PCPQ 220) for the processor 120 to execute. In another example, the PCPQ 220 may include identifiers corresponding to the methods 210 so that the methods 210 may be retrieved.

The PCT generator 230 is configured to generate at least one PCT 240. For example, the PCT 240 may be a kernel-level thread such that the operating system (OS) of the processor system 100 may schedule the PCT 240 to run on the processor 120. The processor 120 may be implemented by either multiple physical processors and/or a single processor with multiple cores or multiple hardware threads (e.g., hyperthreading). Each physical processor, core, or hyperthread represents a logical processor. The PCT generator 230 may generate a number of PCTs 240 based on the number of logical processors available in the processor system 100. To maximize the number of methods 210 that are preemptive compiled, the PCT generator 230 may generate a number of PCTs 240 that is equivalent to the number of logical processors available to the processor system 100. For example, the processor system 100 may include one (1) physical processor with three (3) processing cores, which equates to three (3) logical processors. Accordingly, the PCT generator 230 may generate as many as three (3) PCTs 240 to maximize the number of methods 210 for preemptive compilation. To avoid monopolizing all the resources available and affecting other processes in the processor system 100, however, the PCT generator 230 may generate a number of PCT 240 less than the number of logical processors available to the processor system 100. For example, the PCT generator 230 may generate a number of PCT 240 corresponding to a number of idle logical processors in the processor system 100 (i.e., logical processors that are not currently being used and/or will not be used in the near future).

The compiler 250 may be implemented by a just-in-time (JIT) compiler or a dynamic compiler configured to convert byte code (i.e., platform-independent code that may be sent to and/or run by any platform) of a method into native code (i.e., instructions that may be sent and executed by the processor 120). For example, a program may be compiled by a Java compiler into native code used on a Microsoft Windows® platform and/or a Mac OS platform.

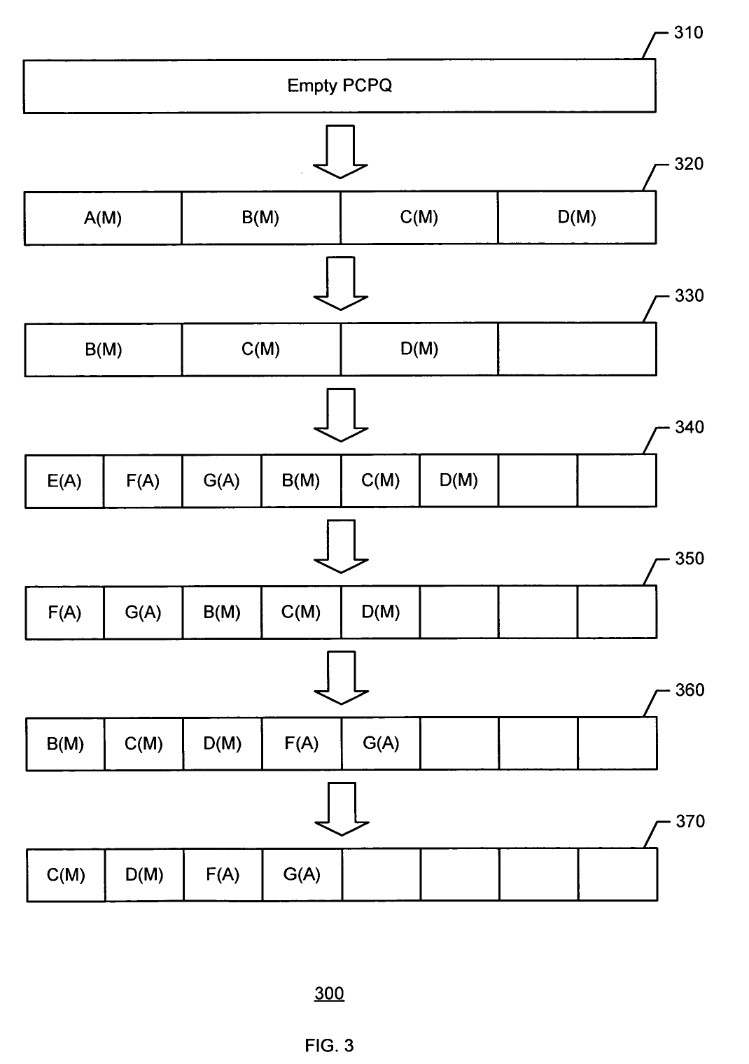

To reduce the initial start-up time of an application executing in a managed runtime environment (MTRE), methods 210 called by the main method of the application are stored the PCPQ 220 while the main method is being JIT compiled (i.e., when the first attempt to invoke the main method is detected). The PCPQ 220 stores methods 210 that are likely to be called soon by the application but have not been compiled into native code for the processor 120 to execute. In the example of FIG. 3, the illustrated PCPQ 300 is initially empty (310) and may be used to store methods 210 called by Method M of an application, which includes Methods A, B, C, and D (320). As methods called by Method M are added to the PCPQ 300, each of those methods are tagged with “M,” which is the method currently being compiled. Some methods may be added to the PCPQ 300 multiple times within the PCPQ 300. By assigning a different tag to that particular method for each instance, all the methods with a particular tag such as “M” may be grouped together in the PCPQ 300. Because Method M may invoke Methods A, B, C, and D, for example, those methods are shown as A(M), B(M), C(M), and D(M), respectively, in the second state 320 of the PCPQ 300.

The PCT 240 generated by the PCT generator 230 may pull Method A of the PCPQ 300 for the compiler 250 to compile as shown in the third state of the (330) of the PCPQ 300. While Method A is being compiled by the compiler 250, the processor 120 may detect approaching calls to Methods E, F, and G. Accordingly, the processor 120 adds those methods to the beginning of the PCPQ 300 as shown in the fourth state (340) of the PCPQ 300. In particular, Method A invokes Methods E, F, and G shown as E(A), F(A), and G(A), respectively. The compiler 250 then extracts and compiles Method E as shown in the fifth state (350) of the PCPQ 300. If Method E calls additional methods then those additional methods are added to the beginning of the PCPQ 300 in a similar manner.

In the absence of method basic block flow information to indicate when a PCPQ entry (e.g., a method) may be executed, the PCPQ entry may be moved to the end of the PCPQ 300. Further, the PCPQ entry is moved from the beginning of the PCPQ 300 to the end of the PCPQ 300 when a method waiting in the middle of the PCPQ 300 is invoked. For example, Methods F and G may be moved to the end of the PCPQ 300 as shown in the sixth state (360) of the PCPQ 300 so that the compiler 250 may extract and compile Method B as shown in the seventh state (370) of the PCPQ 300. The moved PCPQ entries (i.e., Methods F and G) are retained in the PCPQ 300 because the moved PCPQ entries may be invoked in the future by the method that added them to the PCPQ 300 (i.e., Method A).

During the processing of the PCT 240 shown in FIG. 2, the processor 120 may detect that the compiler 250 is still compiling a method (e.g., Method B) when that method is invoked. In this case, the processor 120 may determine whether to wait for the compiler 250 to finish compiling Method B or to swap the PCT 240 with the application execution thread (i.e., the thread running the application that invoked Method B). If the processor 120 swaps the PCT 240 and the application execution thread so that the PCT 240 is the old PCT and the application execution thread is the new PCT, the new PCT begins to compile the next highest priority method in the PCPQ 220 (i.e., the method most likely to be invoked) and the old PCT finishes the compiling of Method B (i.e., JIT compiling Method B). After Method B is compiled, the old PCT starts to run Method B based on the original stack of the new PCT before the swap. That is, the old PCT serves as the application execution thread to run the application that invoked Method B.

In addition to processing method calls as described above, the preemptive compilation system 200 may also process virtual method calls. A virtual method call accesses the root of an inheritance tree that may be translated at runtime into a call to a specific version of a virtual method in any class of the inheritance tree. In fact, the virtual method may be overloaded in every class of the inheritance tree. When the compiler 250 detects that a method extracted into the PCT 240 is virtually invoked, the compiler 250 adds a virtual call entry to the head of the PCPQ 220. The virtual call entry includes a list of versions of the overloaded virtual method that may be invoked by the virtual method call. The size of the virtual call entry may be minimized by 1) excluding methods that are compiled, 2) excluding abstract methods, and/or 3) excluding methods in classes that currently have no objects in existence. When the compiler 250 processes the PCT 240 with a virtual call entry from the PCPQ 220, the compiler 250 compiles all of the methods listed in the virtual call entry. If an application execution thread invokes one of the virtual methods on the virtual call entry before that method has been compiled, the compiler 250 may remove the entire virtual call entry from the PCPQ 220.

After a method is compiled by the compiler 250, the native code associated with the method is stored in the native code cache 260. Accordingly, the processor 120 may retrieve the native code associated with the method from the native code cache 260 and execute the method without having to JIT compile the method when the method is invoked. Thus, the initial start-up time of the application is reduced.

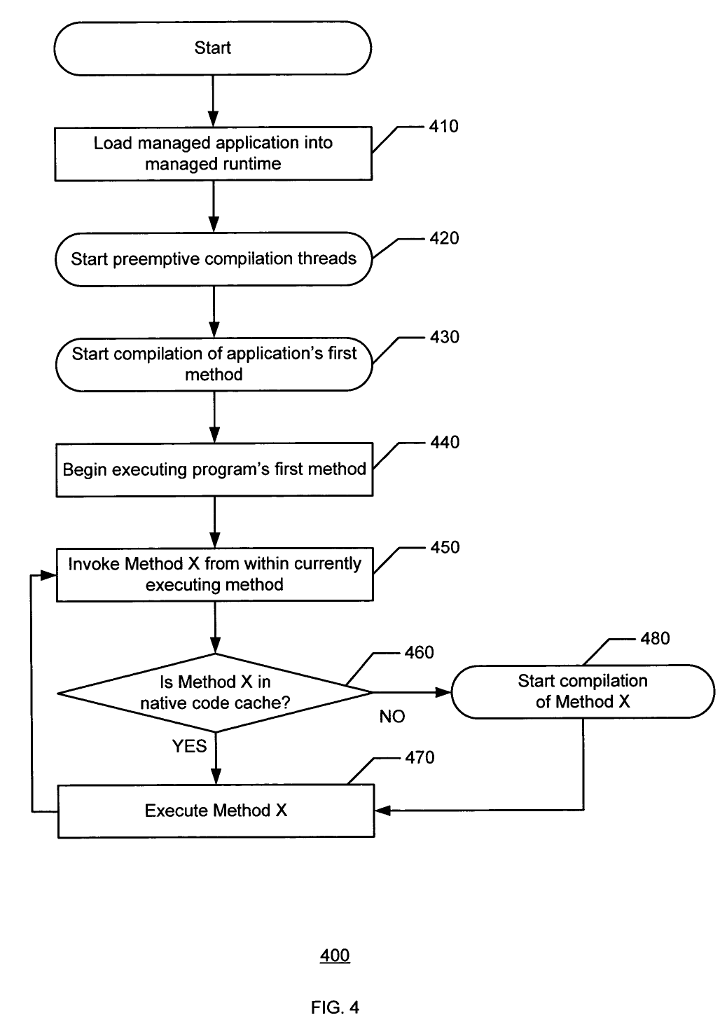

Machine readable instructions that may be executed by the processor system 100 (e.g., via the processor 120) are illustrated in FIG. 4. Persons of ordinary skill in the art will appreciate that the instructions can be implemented in any of many different ways utilizing any of many different programming languages and codes stored on any of many computer-readable mediums such as a volatile or nonvolatile memory or other mass storage device (e.g., a floppy disk, a CD, and a DVD). For example, the machine readable instructions may be embodied in a machine-readable medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of actions is illustrated in FIG. 4, persons of ordinary skill in the art will appreciate that these actions can be performed in other temporal sequences and/or some of these actions can be combined or eliminated. Again, the flow chart 400 is merely provided as an example of one way to program the processor system 100 to perform preemptive compilation of applications.

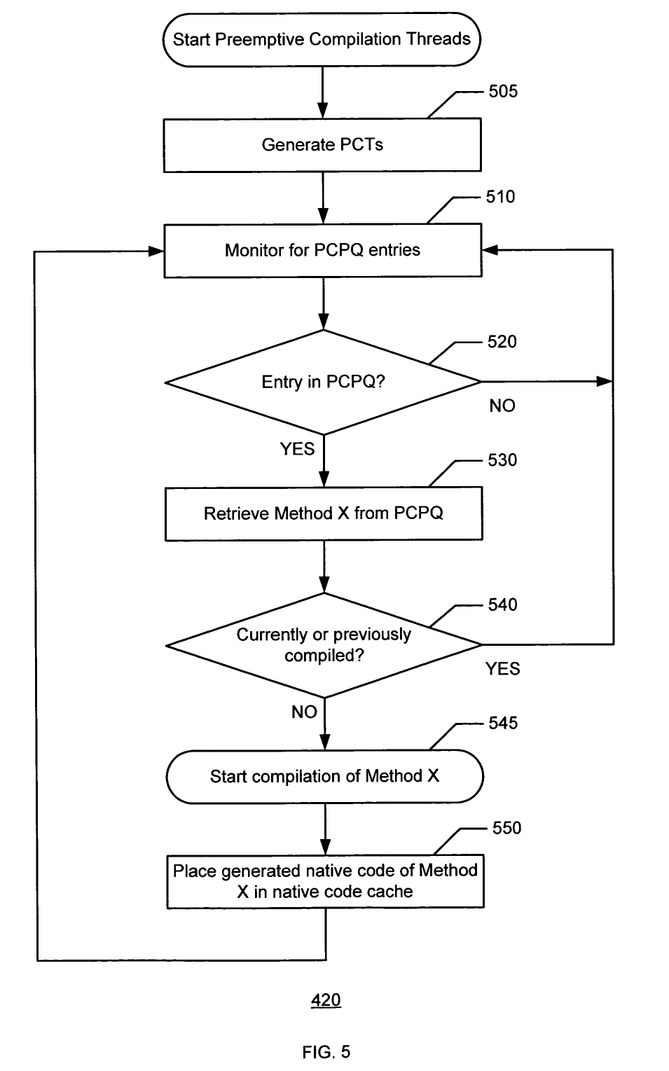

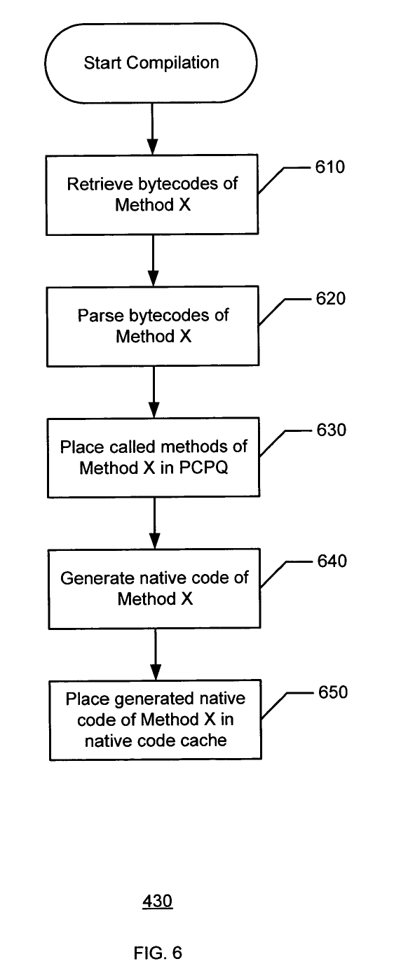

In the example of FIG. 4, the processor 120 executes an application execution thread by loading an application into a managed runtime environment (MRTE) (block 410). In particular, the application may include at least one method (i.e., one or more functions, routines, or subroutines that manipulate data). The processor 120 begins preemptive compilation of methods of the application (block 420) and normal compilation of the first method of the application (block 430) as described in detail below in FIGS. 5 and 6, respectively. For example, the processor 120 may compile the “Main( )” method of an application written in a C# program by executing the activities represented the flow chart of FIG. 6. Accordingly, the processor 120 executes the first method of the application (block 440).

The processor 120 invokes a method (i.e., Method X) from within the currently executed method (i.e., the first method of the application such as the “Main( )” method) (block 450). The processor 120 determines whether Method X has been compiled and its corresponding native code stored in the native code cache 260 (block 460). If the native code associated with Method X is stored in the native code cache 260, the processor 120 proceeds to execute Method X (block 470). If the native code associated with Method X is not stored in the native code cache 260 (block 460), the processor 120 compiles Method X as described in FIG. 6 (block 480) and then proceeds to execute Method M (block 470). Regardless of whether control reached block 470 from block 480 or directly from block 470, after executing Method X control returns to block 450 to invoke other methods from within the currently executed method.

Referring to flow chart 500 in FIG. 5, the processor 120 may perform preemptive compilation by generating at least one PCT (block 505), monitoring for PCPQ entries (block 510), and determining whether there is an entry in the PCPQ 220 (block 520). As noted above, a PCPQ entry may be a method of the application. If there are no entries in the PCPQ 220, the processor 120 returns to block 510. Otherwise, the processor 120 extracts a method of the application from the PCPQ 220 and spawns a PCT 240 (e.g., Method X) (block 530). In particular, the processor 120 extracts the first entry from the PCPQ 220 (i.e., the method having the highest priority because it is most likely to be executed next by the processor 120).

The processor 120 then determines whether the extracted method (i.e., Method X) is currently being compiled or has been compiled (block 540). For example, if Method X is currently being compiled or has been compiled, the processor 120 returns to block 510 to monitor for another PCPQ entry to extract and to preemptive compile into native code. That is, the processor 120 continues to extract methods with the highest priority (i.e., most likely to be executed next by the processor 120) from the PCPQ 220 until a method that has not been compiled is encountered (block 540). If Method X is not currently being compiled or has not been compiled, the processor 120 calls the routine shown in FIG. 6 to compile Method X (block 545) as described in detail below. After Method X has been compiled, the processor 120 stores the native code of the Method X into the native code cache 260 and returns to block 510 to monitor for other PCPQ entries to extract and to preemptive compile into native code.

Referring to flow chart 600 in FIG. 6, the compiler 250 compiles a method by retrieving bytecodes of the method to be compiled (i.e., Method X) (block 610). For example, bytecodes may be a program containing instructions that are converted to instructions for the processor 120 to execute. After retrieving the bytecodes of Method X, the compiler 250 parses the bytecodes to detect methods called by Method X (block 620). If Method X invokes other methods, then those methods are stored in the PCPQ 220 (block 630). For example, Method M may call Methods A, B, C, and D as shown in FIG. 3. Accordingly, the processor 120 may store Methods A, B, C, and D in the PCPQ 220. To illustrate this concept, the methods called by Method M (i.e., Methods A, B, C, and D) may be invoked dynamically by the application in an order similar to the static order of those methods in the bytecodes of Method M. When the processor 120 detects one of those methods, the processor 120 determines whether the method has already been compiled. If the method has not been compiled then the processor 120 adds the method to a list. The contents of the list are placed in the PCPQ 220 in reverse order such that the first method that has not been compiled is the first entry in the PCPQ 220 (320).

Referring back to FIG. 6, the compiler 250 then converts the bytecodes of Method X into native code in a conventional fashion (block 640). The compiler 250 stores the native code associated with Method X in the native code cache 260 (block 650). As a result, the processor 120 may reduce the initial start-up time of the application by using idle resources of the processor system 100 to compile methods 210 of applications prior to invoking those methods 210.

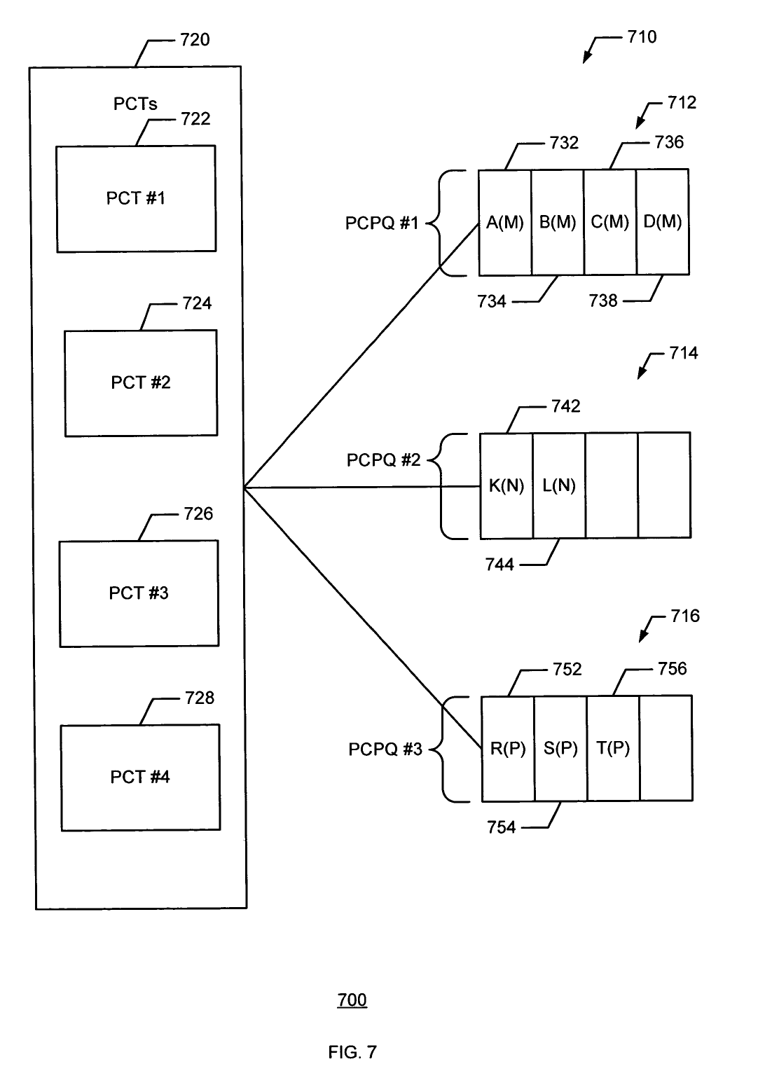

To further optimize resources available, the processor system 100 may include a plurality of PCPQs to perform preemptive compilation for additional application threads. Referring to FIG. 7, for example, the processor system 100 may include a plurality of PCPQs 710, generally shown as PCPQ #1 712, PCPQ #2 714, and PCPQ #3 716. The number of PCPQs may correspond to the number of application execution threads of the processor system 100. That is, each PCPQs may store methods associated with a particular application thread such as Method M, Method N, or Method P. As noted above, the processor system 100 may include a plurality of PCTs 720, generally shown as PCT #1 722, PCT #2 724, PCT #3 726, and PCT #4 728.

To perform preemptive compilation of the methods associated with applications (i.e., Methods M, N, and P), the plurality of PCTs 720 may access the plurality of PCPQs 710 in a round-robin manner. That is, the plurality of PCTs 720 may begin by extracting a method to compile starting from the PCPQ #1 712, then from PCPQ #2 714, and finally from PCPQ #3 716. After extracting a method to compile from each of the plurality of PCPQs 710 (i.e., a “round”), the plurality of PCTs 720 return to the first PCPQ (i.e., PCPQ #1 712) to extract the next method to compile. Accordingly, the plurality of PCTs 720 extract other methods to compile from PCPQ #2 714 and then from PCPQ #3 716.

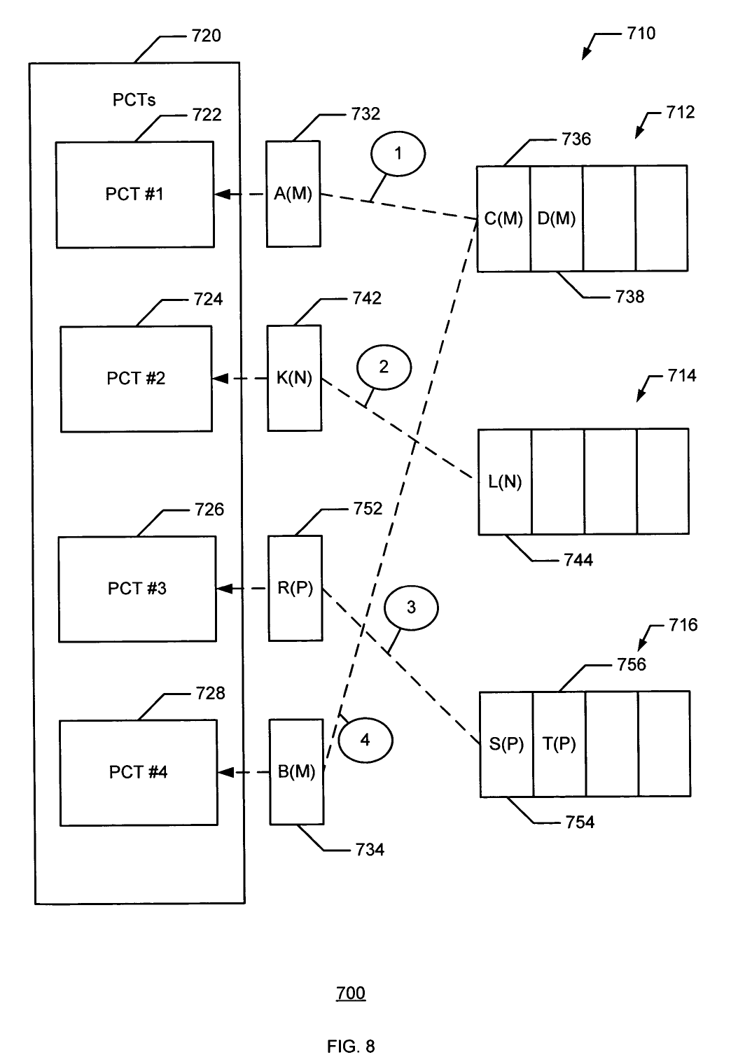

To illustrate this concept, PCPQ #1 712 may store methods associated with Method M, generally shown as Method A 732, Method B 734, Method C 736, and Method D 738. PCPQ #2 714 may store methods associated with Method N, generally shown as Method K 742, and Method L 744. PCPQ #3 716 may store methods associated with Method P, generally shown as Method R 752, Method S 754, and Method T 756. The plurality of PCTs 720 may extract methods associated with Method M, Method N, and Method P. In the example of FIG. 8, PCT #1 722 begins by extracting Method A 732 from PCPQ #1 712 (1), PCT #2 724 extracts Method K 742 from PCPQ #2 714 (2), PCT #3 726 extracts Method R 752 from PCPQ #3 716 (3), and PCT #4 728 extracts Method B 734 from PCPQ #1 712 (4). The plurality of PCTs 720 then compile the methods extracted from the plurality of PCPQs 710 (i.e., Methods A, B, K, and R).

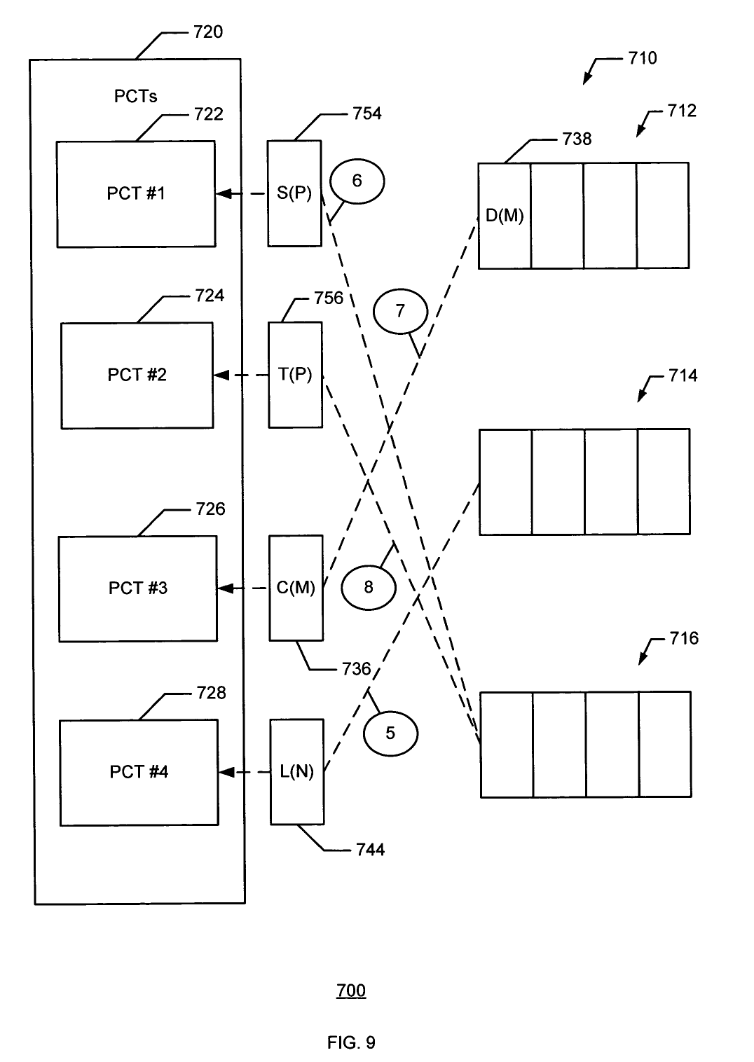

In the illustrated example of FIG. 9, the next “round” begins when one of the plurality of PCTs 720 has completed compiling its corresponding method. In particular, PCT #4 728 completes compiling its corresponding method (i.e., Method K 742) before the other PCTs. Accordingly, PCT #4 728 extracts Method L 744 from PCPQ #2 714 (5). The next PCT to complete compiling its corresponding method may extract and compile the following method in the plurality of PCPQs 710. For example, if PCT #1 722 completes compiling its corresponding method (i.e., Method A 732) before the other PCTs then PCT #1 722 may extract and compile the following method in the plurality of PCPQs 710, which, in the illustrated example, is Method S 754 from PCPQ #3 716 (6).

The next PCT to complete compiling its corresponding method extracts and compiles the next available method in the plurality of PCPQs 710, which, in the illustrated example, is Method C 734 from PCPQ #1 712. For example, if PCT #3 726 completes compiling its corresponding method (i.e., Method R 752) before the other PCTs, then PCT #3 726 extracts and compiles Method C 734 from PCPQ #1 712 (7).

Again, the next PCT to complete compiling its corresponding method extracts and compiles the next available method in the plurality of PCPQs 710. For example, PCT #2 724 may finish compiling its corresponding method (i.e., Method K 742) before the other PCTs. Accordingly, PCT #2 724 may extract the next available method from the plurality of PCPQs 710. Because, in the illustrated example, all the methods stored in PCPQ #2 714 have been extracted by the plurality of PCTs 720, PCT #2 724 extracts the next available method from PCPQ #3 716, which is Method T 756 (8). Thus, the illustrated processor system 100 reduces the initial start-up time of applications by distributing uncompiled methods 210 of applications in a round-robin manner and preemptively compiling those methods before they are invoked.

The methods and apparatus disclosed herein are particularly well suited for use in an MTRE. However, persons of ordinary skill in the art will appreciate that the teachings of the disclosure may be applied to perform preemptive compilation in other suitable environments.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method to compile an application comprising:
generating at least one preemptive compilation thread (PCT);
identifying data associated with at least one method of an application in a preemptive compilation priority queue (PCPQ); and
converting the at least one method identified in the PCPQ into native code with the PCT.

2. A method as defined in claim 1, wherein generating the at least one PCT comprises generating the at least one PCT in response to the application being invoked.

3. A method as defined in claim 1, wherein generating the at least one PCT comprises generating a number of PCTs.

4. A method as defined in claim 1, wherein generating the at least one PCT comprises generating a number of PCTs, and wherein the number of PCTs less than or equal to a number of at least one of a physical processor, a processing core, and a hardware thread in a processor system.

5. A method as defined in claim 1, wherein generating the at least one PCT comprises generating a number of PCTs corresponding to a number of idle logical processors in a processor system.

6. A method as defined in claim 1, wherein identifying data associated with the at least one method of the application in the PCPQ comprises storing the at least one method of the application proximate to the beginning of the PCPQ in response to the at least one method being invoked.

7. A method as defined in claim 1, wherein identifying data associated with the at least one method of the application in the PCPQ comprises storing the at least one method of the application in a number of PCPQs less than or equal to a number of application execution threads, and wherein each of the number of application execution threads corresponds to an application loaded in a managed runtime environment.

8. A method as defined in claim 1, wherein converting the at least one method identified in the PCPQ comprises extracting the at least one method into the at least one PCT in response to detecting an entry in the PCPQ.

9. A method as defined in claim 1, wherein converting the at least one method identified in the PCPQ comprises extracting an uncompiled method associated with one of a priority condition and a virtual call entry from the PCPQ into the at least one PCT.

10. A method as defined in claim 1, wherein converting the at least one method identified in the PCPQ comprises extracting the at least one method from a number of PCPQs in a round-robin manner.

11. A method as defined in claim 1 further comprising storing the native code associated with the method in a native code cache.

12. A machine readable medium storing instructions, which when executed, cause a machine to:
generate at least one preemptive compilation thread (PCT);
identify data associated with at least one method of an application in a preemptive compilation priority queue (PCPQ); and
convert the at least one method identified in the PCPQ into native code with the PCT.

13. A machine readable medium as defined in claim 12, wherein the instructions cause the machine to generate the at least one PCT by generating the at least one PCT in response to the application being invoked.

14. A machine readable medium as defined in claim 12, wherein the instructions cause the machine to generate the at least one PCT by generating a number of PCTs, and wherein wherein the number of PCTs is less than or equal to a number of at least one of a physical processor, a processing core, and a hardware thread in a processor system.

15. A machine readable medium as defined in claim 12, wherein the instructions cause the machine to generate the at least one PCT by generating a number of PCTs corresponding to a number of idle logical processors in a processor system.

16. A machine readable medium as defined in claim 12, wherein the instructions cause the machine to identify data associated with the at least one method of the application in the PCPQ by storing the at least one method of the application proximate to the beginning of the PCPQ in response to the at least one method being invoked.

17. A machine readable medium as defined in claim 12, wherein the instructions cause the machine to identify data associated with the at least one method of the application in the PCPQ by storing the at least one method of the application in a number of PCPQs less than or equal to a number of application execution threads, and wherein each of the number of application execution threads corresponds to an application loaded in a managed runtime environment.

18. A machine readable medium as defined in claim 12, wherein the instructions cause the machine to convert the at least one method identified in the PCPQ by extracting the at least one method into the at least one PCT in response to detecting an entry in the PCPQ.

19. A machine readable medium as defined in claim 12, wherein instructions to cause the machine to convert the at least one method identified in the PCPQ by extracting an uncompiled method associated with one of a priority condition and a virtual call entry from the PCPQ into the at least one PCT.

20. A machine readable medium as defined in claim 12 wherein the instructions cause the machine to convert the at least one method identified in the PCPQ by extracting the at least one method from a number of PCPQs in a round-robin manner.

21. A machine readable medium as defined in claim 12 further comprising instructions cause the machine to store the native code associated with the method in a native code cache.

22. A machine readable medium as defined in claim 12, wherein the machine readable medium comprises one of a programmable gate array, application specific integrated circuit, erasable programmable read only memory, read only memory, random access memory, magnetic media, and optical media.

23. An apparatus to compile an application comprising:
a data structure having a preemptive compilation priority queue (PCPQ) configured to store at least one method of the application; and
a processor programmed to generate at least one preemptive compilation thread (PCT), to identify data associated with at least one method of the application in the PCPQ, and to convert the at least one method identified in the PCPQ into native code with the PCT.

24. An apparatus as defined in claim 23, wherein the processor comprises at least one of a physical processor, a processing core, and a hardware thread in a processor system.

25. An apparatus as defined in claim 23, wherein the at least one PCT comprises a number of PCTs less than or equal to a number of at least one of a physical processor, a processing core, and a hardware thread in a processor system.

26. An apparatus as defined in claim 23, wherein the at least one PCT comprises a number of PCTs corresponding to a number of idle logical processors in a processor system.

27. An apparatus as defined in claim 23, wherein the PCPQ comprise a number of PCPQs less than or equal to a number of application execution threads, and wherein each of the number of application execution threads corresponds to an application in a managed runtime environment.

28. An apparatus as defined in claim 23, wherein the at least one method comprises an uncompiled method associated with one of a priority condition and a virtual call entry.

29. An apparatus as defined in claim 23, wherein the data structure comprises a native code cache configured to store native code associated with the at least one method.

30. A processor system to compile an application comprising:
a dynamic random access memory (DRAM) having a preemptive compilation priority queue (PCPQ) configured to store at least one method of an application; and
a processor programmed to generate at least one preemptive compilation thread (PCT), to identify data associated with at least one method of the application in the PCPQ, and to convert at least one method identified in the PCPQ into native code with the PCT.

31. A processor system as defined in claim 30, wherein the processor comprises at least one of a physical processor, a processing core, and a hardware thread in a processor system.

32. A processor system as defined in claim 30, wherein the at least one PCT comprises a number of PCTs less than or equal to a number of at least one of a physical processor, a processing core, and a hardware thread in a processor system.

33. A processor system as defined in claim 30, wherein the at least one PCT comprises a number of PCTs corresponding to a number of idle logical processors in a processor system.

34. A processor system as defined in claim 30, wherein the PCPQ comprise a number of PCPQs less than or equal to a number of application execution threads, and wherein each of the number of application execution threads corresponds to an application in a managed runtime environment.

35. A processor system as defined in claim 30, wherein the at least one method comprises an uncompiled method associated with one of a priority condition and a virtual call entry.

36. A processor system as defined in claim 30, wherein the DRAM comprises a native code cache configured to store native code associated with the at least one method.

37. A system to compile an application comprising:
a preemptive compilation thread (PCT) generator to generate at least one PCT;
a method identifier to identify methods for possible preemptive compilation;
a preemptive compilation priority queue (PCPQ) to store data associated with the methods identified by the method identifier; and
a compiler to selectively compile a first method identified by the method identifier into native code prior to the first method being invoked for execution.

38. A system as defined in claim 37, wherein the at least one PCT comprises a number of PCTs less than or equal to a number of at least one of a physical processor, a processing core, and a hardware thread in a processor system.

39. A system as defined in claim 37, wherein the at least one PCT comprises a number of PCTs corresponding to a number of idle logical processors in a processor system.

40. A system as defined in claim 37, wherein the PCPQ comprise a number of PCPQs less than or equal to a number of application execution threads, and wherein each of the number of application execution threads corresponds to an application in a managed runtime environment.

41. A system as defined in claim 37, wherein the first method comprises an uncompiled method associated with one of a priority condition and a virtual call entry.
